(19) United States
(12) Patent Application Publication
(10) Pub. No.: US 2026/0210419 A1
(43) Pub. Date: Jul. 23, 2026

(54) ENCAPSULATED BRAKE SYSTEM COMPRISING COOLING CONDUCTORS AND WEDGE GEARS

(71) Applicant: Schaeffler Technologies AG & Co. KG, Herzogenaurach (DE)

(72) Inventors: Doris Maria Wimmer, Ottenhöfen (DE); Simon Ortmann, Pulheim (DE); Benedikt Grubauer, Neresheim (DE); Alan Barrera Bohorquez, Karlsruhe (DE)

(73) Assignee: Schaeffler Technologies AG & Co. KG, Herzogenaurach (DE)

(21) Appl. No.: 19/138,665

(22) PCT Filed: Nov. 16, 2023
(86) PCT No.: PCT/DE2023/100883

§ 371 Date: Jun. 13, 2025

(30) Foreign Application Priority Data
Dec. 15, 2022 (DE) 10 2022 133 457.0

(51) Int. Cl. F16D 65/12; F16D 55/00; F16D 55/225; F16D 65/00; F16D 65/18; F16D 65/853; F16D 121/24; F16D 125/66

(52) U.S. Cl. CPC F16D 65/128; F16D 65/0031; F16D 65/18; F16D 65/853; F16D 2055/0058; F16D 55/225; F16D 2121/24; F16D 2125/66

(57) ABSTRACT

A brake assembly includes a housing with a first braking surface, a shaft, a brake disk, a second braking surface, a wedge gear and a cooling conductor. The shaft is rotatably mounted on a main body of the housing. The brake disk is mounted on the shaft for conjoint rotation therewith. The brake disk is axially displaceable relative to the main body to contact the first braking surface, and the second braking surface is axially displaceable relative to the main body. The wedge gear is engaged with the main body and the second braking surface and moves transverse to a central axis to move the second braking surface against the brake disk and the brake disk against the first braking surface. The cooling conductor is thermally coupled to and dissipates a heat generated at the first braking surface and the second braking surface during braking.

### CROSS-REFERENCE TO RELATED APPLICATIONS

This application is the United States National Phase of PCT Appln. No. PCT/DE2023/100883 filed Nov. 16, 2023, which claims priority to German Application No. DE102022133457.0 filed Dec. 15, 2022, the entire disclosures of which are incorporated by reference herein.

### TECHNICAL FIELD

The present disclosure relates to the braking of a rotating axle, in particular a drive axle in an automobile, in particular in a BEV (battery electric vehicle), in particular therefore the braking of an automobile.

### BACKGROUND

It is common practice to use a conventional disk brake to brake an axle. The axle is coupled for conjoint rotation with a brake disk. When braking is required, the brake blocks frictionally engage the brake disk to brake the axle.

### SUMMARY

The present disclosure provides improvements with regard to the braking of an axle.

Example embodiments arise from the following description and the appended figures.

The brake assembly serves or is configured for an axle to be braked, i.e., for braking the rotation of the axle about its central longitudinal axis. In particular, the axle is part of a chassis/drive train of a vehicle. For example, it is a driven or non-driven wheel axle or an axle that is rotationally coupled to these. The coupling can take place, for example, via additional axles, transmissions, clutches, etc. The brake assembly causes braking of the axle, i.e., applies a braking torque to the axle. In particular, the axle is that of a battery electric vehicle.

The brake assembly contains a housing. The housing encloses an interior. The brake assembly contains a main body. This forms a mechanical support or main structure for the rest of the brake assembly and is firmly connected to a vehicle part, for example, in order to receive or divert the braking torque of the axle.

The brake assembly contains a shaft. The shaft is rotatably mounted on the main body about its central longitudinal axis and in particular is fixed axially on the main body. The shaft extends at least partially in the interior. The shaft has a connecting flange. This is accessible on the outside of the housing and is connected for conjoint rotation with the axle in at least one desired braking direction of rotation. In other words, the drive axle can be coupled for conjoint rotation with the shaft via the connecting flange, at least for transmitting a braking torque from the brake assembly to the drive axle. ‘Has’ is therefore to be understood broadly and includes any type of coupling in relation to the braking torque.

The connecting flange can therefore also be indirectly connected to the shaft, for example via a deflection, a transmission gearing, etc. In the simplest case, however, in particular the shaft itself directly has the connecting flange. This means that the connecting flange is a flange end of the shaft.

The brake assembly contains a brake disk. The brake disk is located in the interior and can be displaced axially in relation to the main body, i.e., relative to the main body. ‘Axial’ here refers to the central longitudinal axis/axis of rotation of the shaft and brake disk. The brake disk is also mounted on the shaft for conjoint rotation therewith. The decisive factor here is the axial displaceability of the brake disk relative to the main body. This can be achieved by the brake disk being axially fixed on the shaft itself and being axially displaceable together with the shaft in the main body or relative to it. In particular, however, the shaft is mounted in an axially fixed manner in the main body and the brake disk is mounted axially displaceably on/relative to the shaft.

The main body has a first braking surface in the interior. Owing to its axial displaceability, the brake disk can be moved in the axial direction to the braking surface and lifted off it. A surface normal of the generally flat braking surface therefore points in the axial direction. The brake disk is moved to the braking surface by its above-mentioned axial displacement relative to the main body, in particular on the shaft or in relation to or relative to the shaft.

The brake assembly contains a second braking surface. As viewed in the axial direction, said second braking surface lies on the other side of the brake disk with respect to the first braking surface, i.e., on its other flat side. In addition, the second braking surface is movably or displaceably mounted in the axial direction in relation/relative to the main body. The surface normal of the second—usually also flat—braking surface also points in an axial direction, but in the opposite direction to the surface normal of the first braking surface. In other words, the two braking surfaces are arranged opposite with respect to the brake disk or on both sides of the brake disk and face each other in order to enclose the brake disk between them like pliers. In other words, according to the brake assembly, the brake disk is frictionally clamped between the first and second braking surfaces during the braking process.

The brake assembly contains a wedge gear. This engages between the main body and the second braking surface, i.e., it causes the second braking surface to move relative to the main body. The wedge gear is configured to move the second braking surface in an axial direction relative to the main body against the brake disk (or away from it). By exerting pressure on the brake disk in the axial direction towards the first braking surface, the wedge gear is also configured to move the brake disk in the axial direction against the first braking surface, i.e., by axially displacing the entire brake disk.

The wedge gear is driven transverse to the axial direction, in particular exclusively in a radial direction. In other words, a drive or actuator acts transverse to the axial direction, in particular in a radial direction, on the wedge gear, in particular a wedge thereof, in order to drive or move it. In particular, the wedge gear is also configured to actively move the second braking surface in the opposite direction, i.e., away from the brake disk. In particular, there is also a return means to lift the brake disk axially from the first braking surface, e.g., by spring force. This creates clearance on both sides of the brake disk with respect to the two braking surfaces if no braking effect is desired.

The brake assembly contains a cooling conductor. The cooling conductor is in particular a cooling channel through which a coolant can flow. The cooling conductor is configured to absorb heat from its surroundings and transport it away from there. The cooling conductor is thermally coupled to at least the two braking surfaces and is configured to dissipate heat generated at the braking surfaces (and the brake disk) during braking of the rotating brake disk at least from the two braking surfaces or from the surroundings of the braking surfaces (housing/main body). ‘At least’ means that the cooling conductor can also be thermally coupled with other parts/regions of the brake assembly/housing/main body, so heat can also be dissipated from there. Braking is the process when the braking surface and brake disk rub against each other. The heat generated is the corresponding frictional heat. ‘The cooling conductor’ within the meaning of the present application can have a plurality of partial sections or ‘the cooling conductor’ can also be a plurality of individual cooling conductors which dissipate heat from the two braking surfaces or other points of the brake assembly accordingly.

It can be assumed that future legislation will provide for a limit on particulate matter pollution from automobiles. A solution is therefore being sought to prevent the emission of brake dust particles into the environment. At the same time, it is desirable to use the waste heat from braking in a system such as an automobile. A range extension or efficiency increase, for example, can be achieved in the automobile. This is achieved by the fact that no heat or less heat has to be generated in the vehicle through the conversion of electrical or other necessary energy. Heat is required, for example, to heat the traction battery of an electric vehicle (BEV), to preheat the traction electric motor or to heat a passenger compartment.

These considerations are applicable not only to automobiles or their drive train/chassis, but to any axles, drive trains or drive axles which may need to be braked. The present disclosure can therefore be applied to any axle to be braked, but in particular to drive or drive axles in an electric motor-driven electric vehicle.

According to the disclosure, it is possible to reduce the brake dust emission for the axle to be braked; see below the encapsulation by the housing. It is also possible to increase system efficiency in the system with the axle/brake assembly by making the heat dissipated from the brake assembly during braking available and usable at the cooling line.

In particular, the heat generated in an electric vehicle can also be used when the battery is ‘full’. Conversely, it would no longer be possible to electrically store braking power/braking energy alternatively converted into electrical energy by a brake generator.

According to the disclosure, the brake assembly is installed on an axle, for example a drive train of an electric vehicle, as a supplementary brake system. The axle can be the drive axle or a vehicle axle without a drive. The brake assembly then supplements recuperation of the electric motor in particular in driving situations in which recuperation cannot receive all or any of the braking energy. These are, for example, driving situations with low speed/rotational speed or stopping to a standstill or braking processes at low temperatures. With an additional (encapsulated) brake (i.e., the brake assembly), the braking energy can be transferred as heat to a thermal management system in the system (without the energy having to be stored in the battery in the meantime). In addition, brake dust particles are not released into the environment when encapsulated.

The brake assembly is a disk brake system in which the rotating brake disk is axially displaceably mounted on the shaft, in particular on a tooth system. The brake disk is pressed axially against the housing (main body, first braking surface), in particular with the aid of a brake pad (wedge, in particular with a second braking surface; see below), which is actuated radially against an oblique additional contact surface (inclined surface; see below). Cooling channels (generally: cooling conductors) are installed in particular in (under) this additional contact surface (inclined surface) and the friction surface with respect to the housing (first braking surface), and a cooling liquid flows through said cooling channels, which are connected, for example, to the cooling circuit of a thermal management system.

According to the disclosure, the result is in particular an encapsulated, supplementary brake system, radially actuated, with cooling channels in the housing.

In an example embodiment, at least a partial section of the cooling conductor, in particular the entire cooling conductor, is embedded in the main body. In particular, these are recesses/holes/cut-outs, etc. in the main body. In other words, the cooling conductor extends inside the main body. In particular, it extends in a heat path that is coupled in a thermally favorable manner to the braking surfaces, especially in the vicinity of the two or at least one of the braking surfaces. This means that heat generated on the braking surfaces during the braking process can be dissipated particularly effectively through the cooling conductor and reused.

In an example embodiment, at least a partial section of the cooling conductor, in particular the entire cooling conductor, therefore extends in the region of the first braking surface. ‘In the region’ is to be understood in such a way that it extends as tight or as close as possible to or under the braking surface in a body, e.g., the main body, that has/carries the braking surface. This means that the cooling conductor is placed so close to/‘under’ the braking surface that the strength requirements of the body are just about sufficiently met to ensure sufficient mechanical stability of the body or the braking surfaces.

In an example embodiment, the wedge gear has an inclined surface of the main body that extends obliquely with respect to the axial direction. The wedge gear also has a wedge. The wedge can also be moved in an axial direction, i.e., towards the brake disk, by displacing it along the inclined surface. The displacement is caused by a drive of the wedge gear. The inclined surface therefore extends obliquely with respect to the axial direction, i.e., neither parallel nor perpendicular to it. The inclined surface is in particular flat. In other words, the displacement movement of the wedge on the inclined surface contains a component transverse to the axial direction, in particular exclusively in a radial direction, as well as a component in the axial direction. The wedge therefore slides on the inclined surface directly on the main body. A corresponding wedge gear is particularly easy to implement.

In an example embodiment, the second braking surface is a surface section of the wedge facing the brake disk. In particular, the wedge gear is configured in such a way that the surface normal of the braking surface always points in the axial direction, i.e., it always remains oriented in this way even when the wedge is displaced on the inclined surface. In other words, the wedge itself acts both as a carrier/means of movement for the braking surface and at the same time as a brake block/brake lining. This results in a particularly simple brake assembly.

In an example embodiment, at least one partial section of the cooling conductor is arranged in the region of the inclined surface. ‘In the region’ is again to be understood analogously as above in relation to the first braking surface, such that, for example, the cooling conductor is so close under the inclined surface that the strength requirements of the inclined surface are still just sufficiently met. In other words, the cooling conductor is located inside the main body ‘under’ the inclined surface. In particular, the wedge is thermally conductive in order to transfer heat from the second braking surface to the inclined surface so that it can be effectively dissipated from the inclined surface. In other words, heat flows from the second braking surface via the wedge and the inclined surface to the cooling conductor during braking.

In an example embodiment, the wedge gear is electrically, in particular exclusively electrically, actuated. This means, for example, that there is no need for separate brake hydraulics etc.

In an example embodiment, the housing is designed to be dust-tight with regard to brake dust that arises in relation to an outer space surrounding the housing. In other words, this prevents brake dust from leaving the brake assembly or the housing. Brake dust is generated, for example, by abrasion of the brake disk or the material on the braking surfaces, in particular brake blocks.

In an example embodiment, the main body is at least a part of the housing or vice versa (housing is at least a part of the main body). In particular, the housing and main body are identical. The housing therefore also serves in particular as a mechanical frame/holder/carrier for the rest of the brake assembly.

In an example embodiment, the brake assembly contains at least one—in particular exchangeable—brake lining. The following applies: At least one of the brake linings is a part of the main body. In other words, a part of the main body is designed as a brake lining. The brake lining thus forms the first braking surface or at least part of the first braking surface. In other words, for example, a brake lining is arranged on the main body, but is understood as part of the main body for the purposes of the application. The corresponding brake lining is designed as a brake block, for example, which can also be exchangeable so that it can be replaced when worn, for example.

Alternatively or additionally, at least one of the brake linings has the second braking surface or forms at least part of the second braking surface. In particular, the brake lining is designed as the above-mentioned wedge or part of the wedge. In other words, the wedge in particular includes the brake lining or the brake lining is part of the wedge. As above, the unit comprising the brake lining and the actual wedge is therefore understood as a ‘wedge’ within the meaning of the present application.

Alternatively or additionally, at least one of the brake linings is part of the brake disk and is configured to bear against the first and/or second braking surface. Here too, the brake lining is applied to an actual brake disk, for example, but is to be understood as part of the brake disk for the purposes of the disclosure. Brake linings on the brake disk in particular can be designed to be thermally insulating or as thermally poorly conductive as possible. The heat generated during braking is therefore dissipated minimally to the disk, but is instead dissipated to the first/second braking surface and can be transported away from there via the cooling conductor. This minimizes the thermal load on the brake disk.

### BRIEF DESCRIPTION OF THE DRAWINGS

Further features, effects and advantages of the disclosure are derived from the following description of an exemplary embodiment and the attached figures. In each case, a schematic diagram is shown:

FIG. 1 shows a cross-section of a brake assembly; and

FIG. 2 shows a detail of an alternative brake assembly as shown in FIG. 1.

### DETAILED DESCRIPTION

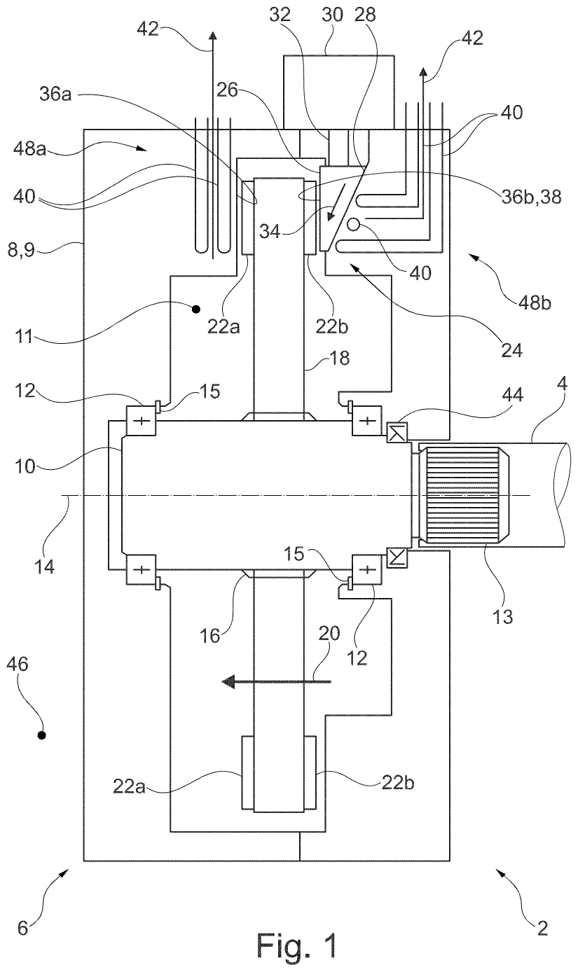

FIG. 1 shows a detail of a vehicle 2, in this case a battery electric vehicle in the form of a passenger car. Only one axle 4 and one brake assembly 6 vehicle 2 are shown. The axle 4 is a driving axle (motorized or not), which is connected to the wheels of the vehicle 2 in a torque connection. The axle 4 can be braked to brake the vehicle 2.

The brake assembly 6 is used to brake the axle 4. The brake assembly 6 contains a housing 8. The brake assembly 6 has a main body 9, which is formed here by the housing 8. The housing 8 is therefore identical to the main body 9. The main body is therefore at least a part, namely the mechanically load-bearing part, of the housing 8. The main body 9 forms a mechanically stable main frame for the rest of the brake assembly 6 in order to absorb the braking forces generated during braking. For this purpose, the main body 9 is firmly attached to a frame (not shown) of the vehicle 2. The housing 8 encloses an interior 11 of the brake assembly 6.

A shaft 10 of the brake assembly 6 is mounted on the housing 8 and on the main body 9 by means of bearings 12. The shaft 10 can be rotated about its central longitudinal axis 14 relative to the housing 8/main body 9, but is fixed in the axial direction of the central longitudinal axis 14. Retaining rings 15 secure or hold the bearings 12.

The shaft 10 is connected for conjoint rotation with the axle 4 and thus to the drive or to the wheels of the vehicle 2. For this purpose, it has a connecting flange 13 that is accessible outside the housing 8. The shaft 10 has a tooth system 16 in the interior 11. The shaft 10 therefore constitutes a connection of the brake assembly 6 in the direction of the drive.

The brake assembly 6 also contains a brake disk 18 in the interior 11. The brake disk 18 is mounted on the tooth system 16 or by means of this on the shaft 10, such that both are connected to each other for conjoint rotation. However, the brake disk 18 can be displaced axially (in and counter to the direction of the arrow 20) on the shaft 10 and thus within the housing 8 or relative to the housing 8. A braking torque applied to the brake disk 18 can therefore be transmitted to the vehicle 2 or its wheels/engine via the tooth system 16, shaft 10, connecting flange 13 and axle 4. Axial movement of the brake disk 18 on the shaft 10 is therefore permitted.

A brake lining 22a, b is installed radially on the outside of the brake disk 18 on both flat sides, i.e., axially, and extends in each case as a circular ring circumferentially around the central longitudinal axis 14. For the purposes of the application, the brake lining 22a, b is considered to be part of the brake disk 18. The brake disk 18 is therefore a rotating, axially displaceable disk. The brake linings 22a, b are therefore friction linings. The tooth system 16 is therefore arranged between the brake disk 18 and the shaft 10 and is used to transmit braking torque.

The brake assembly 6 also contains a wedge gear 24. This contains a wedge 26 and an inclined surface 28 arranged or installed on the main body 9. The wedge 26 can be moved parallel to the inclined surface 28 (in or counter to the direction of the arrow 34) via a purely electric drive 30 and a pin 32 that moves purely in a radial direction with respect to the central longitudinal axis 14. The wedge 26 performs a movement that includes both a radial and an axial component. The drive 30 is therefore an actuating unit. The pin 32 therefore constitutes a connection between the wedge 26 and the actuating unit. The wedge 26 assumes the function of a brake pad in this case:

When the drive 30 is actuated or the pin 32 is moved in the radially inward direction, the wedge 26 moves in the direction of the arrow 34. As a result, the wedge 26 also moves to the brake lining 22b in an axial direction or in the direction of the arrow 20. This therefore uses up a clearance between the wedge 26 and the brake lining 22b or the brake disk 18. During a further movement in the direction of the arrow 20, the wedge 26 also pushes the entire brake disk 18 relative to the shaft 10 in the direction of arrow 20 until the brake lining 22a or the brake disk 18 comes into contact with a first braking surface 36a on the main body 9 or is pressed against/rubs against it in a braking manner.

A section of a surface 38 of the wedge 26 acts as a second braking surface 36b, which also rubs against the brake disk 18 (its brake lining 22b) in a braking manner. In other words, the clearance between the brake disk 18 and main body 9 is also used up. Further movement of the wedge 26 in the direction of the arrow 20 increases the frictional pressure on the braking surfaces 36a, b and increases the braking effect of the brake assembly 6, i.e., the shaft 10 and thus the axle 4 are braked increasingly more strongly. The second braking surface 36b is therefore a surface section of the wedge 26 facing the brake disk 18.

The braking surfaces 36a, b are arranged in the interior 11. The second braking surface 36b therefore lies on the other side of the brake disk 18 axially (central longitudinal axis 14) with respect to the first braking surface 36a. The braking surface 36b is therefore mounted movably in an axial direction relative to the main body 9.

The wedge gear 24 therefore engages between the main body 9 and the second braking surface 36b and is driven transverse to the axial direction. The wedge gear 24 is therefore configured to move the second braking surface 36b in an axial direction (arrow 20) relative to the main body 9 against the brake disk 18 and thus to move the brake disk 18 in an axial direction against the first braking surface 36a.

Cooling conductors 40, in this case in the form of cooling channels, are integrated in the main body 9. In this case, these are each installed in the vicinity of or in a thermal path for brake heat which leads away from the first and second braking surfaces 36a, b. Heat generated by the frictional contact of the brake linings 22a, b on the braking surfaces 36a, b is dissipated or transferred via the cooling conductors 40 in the main body 9 or the housing 8, as indicated by arrows 42. The heat is conducted, for example, to a heat management system (not shown) of the vehicle 2, where it is further processed or used.

The cooling conductor 40 is therefore thermally coupled to the two braking surfaces 36a, b and is configured to dissipate heat generated during braking from the two braking surfaces 36a, b. Partial sections 48a, b of the cooling conductor 40 are embedded in the main body 9. The partial section 48a extends in the region of the first braking surface 36a, i.e., sufficiently close to the braking surface 36a, to absorb heat which is generated. However, it is far enough away to leave sufficient material thickness of the main body 9 so that the latter can durably absorb the mechanical and thermal loads on the first braking surface 36a during braking. The partial section 48b of the cooling conductor 40 is arranged in the region of the inclined surface 28. In this case also, the above applies to the arrangement ‘in the region’ with regard to the compromise between thermal coupling and mechanical load capacity.

The inclined surface 28 creates a self-reinforcing effect during braking, which is beneficial if the actuating device in the form of the drive 30/pin 32 is operated electromechanically instead of hydraulically. Electromechanical actuation also allows the brake to be fully released when not actuated. This means that the wedge 26 actively moves back counter to the direction of the arrows 20 or 34 so that the clearance shown in FIG. 1 actually forms again between the two brake linings 22a, b and braking surfaces 36a, b.

Due to a seal 44, the interior 11 is designed/sealed against brake dust (not shown) in relation to an outer space 46 of the brake assembly 6. Brake dust is produced during braking processes, for example by abrasion of the brake linings 22a, b. Brake dust that arises can therefore not pass into the surroundings or the outer space 46 of the brake assembly 6. The seal 44 here is a radial shaft seal ring.

In FIG. 1, the brake linings 22a, b are therefore parts of the brake disk 18 and are configured to bear against the first and second braking surfaces 36a, b.

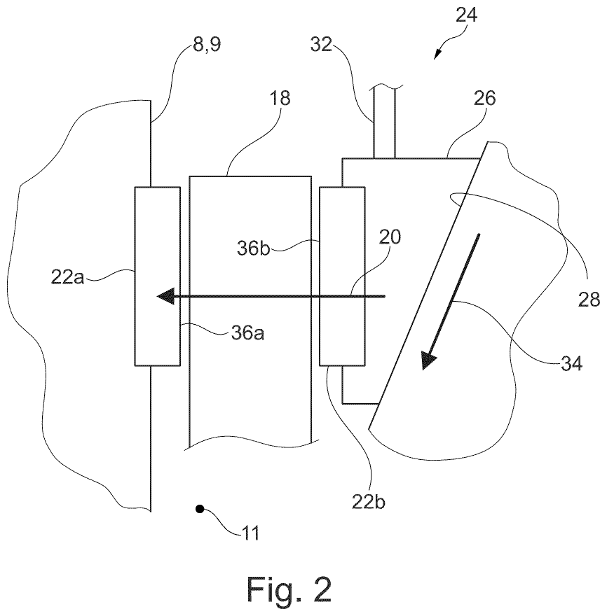

FIG. 2 shows an alternative variant or embodiment of the brake assembly 6. In this case, the brake linings 22a, b are not attached to the brake disk 18. An alternative brake lining 22a, on the other hand, is installed on the main body 9 or forms part of the main body 9. The first braking surface 36a is then formed by the surface of the brake lining 22a.

The brake lining 22b is then installed on the wedge 26 or forms part of this wedge 26. The second braking surface 36b is thus formed by the surface of the brake lining 22b. The brake disk 18 then comes into direct contact with the braking surfaces 36a, b (without it itself again carrying/having brake linings).

In FIG. 2, the first brake lining 22a is therefore part of the main body 9 and forms the first braking surface 36a. The brake lining 22b includes the second braking surface 36b and is part of the wedge 26. This means that the wedge 26 also includes the second braking surface 36b.

### REFERENCE NUMERALS

2 Vehicle
4 Axle
6 Brake assembly
8 Housing
9 Main body
10 Shaft
11 Interior space
12 Bearing
13 Connecting flange
14 Central longitudinal axis
15 Retaining ring
16 Tooth system
18 Brake disk
20 Arrow
22a, b Brake lining
24 Wedge gear
26 Wedge
28 Inclined surface
30 Drive
32 Pin
34 Arrow
36a, b First, second braking surface
38 Surface
40 Cooling conductor
42 Arrow
44 Seal
46 Outer space
48a, b Partial section (cooling conductor)

1. A brake assembly for an axle to be braked, comprising:
a housing enclosing an interior and having a main body,
a shaft which is rotatably mounted on the main body about a central longitudinal axis, extending at least partially in the interior, and which has a connecting flange, accessible on an outside of the housing, for the axle, and
a brake disk which is located in the interior and which is mounted on the shaft for conjoint rotation therewith and so as to be axially displaceable relative to the main body with respect to the central longitudinal axis, wherein:
in the interior, the main body has a first braking surface, to which the brake disk can be moved in an axial direction of the central longitudinal axis, the brake assembly further comprising:
a second braking surface, which lies on the other side of the brake disk axially with respect to the first braking surface and is mounted axially movably relative to the main body,
a wedge gear which engages between the main body and the second braking surface and is driven transverse to the axial direction, which is configured to move the second braking surface in an axial direction relative to the main body against the brake disk and thus the brake disk in the axial direction against the first braking surface, and
a cooling conductor which is thermally coupled at least to the first braking surface and the second braking surface and which is configured to dissipate heat generated during braking at least from the first braking surface and the second braking surface.

2. The brake assembly according to claim 1, wherein:
at least a partial section of the cooling conductor is embedded in the main body.

3. The brake assembly according to claim 1,
wherein:
at least a partial section of the cooling conductor extends proximate the first braking surface.

4. The brake assembly according to claim 1,
wherein:
the wedge gear has an inclined surface of the main body extending obliquely with respect to the axial direction and a wedge which can also be moved in the axial direction by displacement along the inclined surface.

5. The brake assembly according to claim 4,
wherein:
the second braking surface is a section of a surface of the wedge facing the brake disk.

6. The brake assembly according to claim 4,
wherein:
at least a partial section of the cooling conductor is arranged proximate the inclined surface.

7. The brake assembly according to claim 1,
wherein:
the wedge gear is electrically actuated.

8. The brake assembly according to claim 1,
wherein:
the housing is designed to be dust-tight in relation to an outer space surrounding the housing with respect to brake dust that arises.

9. The brake assembly according to claim 1,
wherein:
the main body is at least a part of the housing or vice versa.

10. The brake assembly according to claim 1,
wherein:
the brake assembly contains at least one brake lining, and
at least one of the brake linings is a part of the main body and forms the first braking surface, or
at least one of the brake linings has the second braking surface, or
at least one of the brake linings is a part of the brake disk and is configured to bear against the first braking surface or the second braking surface.

11. A brake assembly for an axle, comprising:
a central longitudinal axis defining an axial direction;
a housing enclosing an interior and comprising a main body, the interior comprising a first braking surface;
a shaft, rotatably mounted on the main body about the central longitudinal axis and extending into the interior, the shaft comprising a connecting flange for the axle, accessible on an outside of the housing;
a brake disk, located in the interior and mounted on the shaft for conjoint rotation therewith, the brake disk arranged to be axially displaceable relative to the main body to contact the first braking surface;
a second braking surface, arranged to be axially displaceable relative to the main body;
a wedge gear, engaged with the main body and the second braking surface and arranged to move transverse to the central longitudinal axis to move the second braking surface against the brake disk and the brake disk against the first braking surface; and
a cooling conductor, thermally coupled to and arranged to dissipate a heat generated at the first braking surface and the second braking surface during braking.

12. The brake assembly of claim 11, wherein a partial section of the cooling conductor is embedded in the main body.

13. The brake assembly of claim 11, wherein a partial section of the cooling conductor is arranged proximate the first braking surface.

14. The brake assembly of claim 11, wherein the wedge gear comprises:
an inclined surface of the main body extending obliquely relative to the central longitudinal axis; and
a wedge, axially movable when displaced along the inclined surface.

15. The brake assembly of claim 14, wherein the wedge comprises the second braking surface.

16. The brake assembly of claim 14, wherein a partial section of the cooling conductor is arranged proximate the inclined surface.

17. The brake assembly of claim 11, wherein the wedge gear is electrically actuated.

18. The brake assembly of claim 11, wherein the housing is dust-tight with respect to brake dust.

19. The brake assembly of claim 11 further comprising a brake lining, wherein:
the brake lining is a part of the main body and forms the first braking surface;
the brake lining comprises the second braking surface; or
the brake lining is a part of the brake disk and arranged to contact the first braking surface or the second braking surface.
